(19) United States
(12) Patent Application Publication
(10) Pub. No.: US 2024/0221224 A1
(43) Pub. Date: Jul. 4, 2024

(54) METHOD, APPARATUS, AND SYSTEM FOR DETERMINING A VELOCITY OF A MOVING OBJECT BASED ON CHROMATIC SIGNATURES IN AN IMAGE

(71) Applicant: HERE Global B.V., Eindhoven (NL)

(72) Inventor: Dennis Scott WILLIAMSON, Wheaton, IL (US)

(21) Appl. No.: 18/088,320

(22) Filed: Dec. 23, 2022

(51) Int. Cl. G06T 7/90; G06T 7/20

(52) U.S. Cl. CPC G06T 7/90; G06T 7/20; G06T 2207/10024; G06T 2207/10032; G06T 2207/30236

(57) ABSTRACT

An approach is provided for determining a velocity of a moving object based on chromatic signatures in an image. For example, the approach involves obtaining an image of a moving object captured using a camera sensor. The camera sensor employs a plurality of successive color filters to capture the image, and the plurality of successive color filters creates a chromatic signature of the moving object in the image. The approach also involves determining a velocity, a speed, a direction of travel, or a combination thereof of the moving object based on the chromatic signature. The approach further involves providing the velocity, the speed, the direction of travel, or a combination thereof as an output.

### BACKGROUND

Speed of a vehicle is commonly determined using the satellite-based positioning sensor data, such as Global Positioning System (GPS) signals. However, GPS signals are susceptible to atmospheric interference, calculation and rounding errors, ephemeris (orbital path) data errors, multi-path effects, etc. The problem of unavailability of GPS signals in certain locations is usually addressed by using an inertial measurement unit (IMU), such as, an accelerometer and a gyroscope to determine distance, using which speed of the vehicle is determined. Such solutions require an integration of samples of sensor data from different sensors and thus, such solutions suffer from synchronization problems between the sensors and drift errors. Accordingly, there is a need for a new approach to efficiently and effectively estimating the speed data of the vehicle or other moving objects.

### SOME EXAMPLE EMBODIMENTS

Therefore, there is a need for a new approach to efficiently and effectively estimating the velocity data of a moving object (e.g., a vehicle), such as via determining a velocity of a moving object based on its chromatic signature in an image.

According to example embodiment(s), a method comprises obtaining an image of a moving object captured using a camera sensor. The camera sensor employs a plurality of successive color filters to capture the image, and the plurality of successive color filters creates a chromatic signature of the moving object in the image. The method also comprises determining a velocity, a speed, a direction of travel, or a combination thereof of the moving object based on the chromatic signature. The method further comprises providing the velocity, the speed, the direction of travel, or a combination thereof as an output.

According to another embodiment, an apparatus comprises at least one processor, and at least one memory including computer program code for one or more computer programs, the at least one memory and the computer program code configured to, with the at least one processor, cause, at least in part, the apparatus to obtain an image of a moving object captured using a camera sensor. The camera sensor employs a plurality of successive color filters to capture the image, and the plurality of successive color filters creates a chromatic signature of the moving object in the image. The apparatus is also caused to determine a velocity, a speed, a direction of travel, or a combination thereof of the moving object based on the chromatic signature. The apparatus is further caused to provide the velocity, the speed, the direction of travel, or a combination thereof as an output.

According to another embodiment, a computer-readable storage medium carries one or more sequences of one or more instructions which, when executed by one or more processors, cause, at least in part, an apparatus to obtain an image of a moving object captured using a camera sensor. The camera sensor employs a plurality of successive color filters to capture the image, and the plurality of successive color filters creates a chromatic signature of the moving object in the image. The apparatus is also caused to determine a velocity, a speed, a direction of travel, or a combination thereof of the moving object based on the chromatic signature. The apparatus is further caused to provide the velocity, the speed, the direction of travel, or a combination thereof as an output.

According to another embodiment, a computer program product may be provided. For example, a computer program product comprising instructions which, when the program is executed by a computer, cause the computer to obtain an image of a moving object captured using a camera sensor. The camera sensor employs a plurality of successive color filters to capture the image, and the plurality of successive color filters creates a chromatic signature of the moving object in the image. The computer is also caused to determine a velocity, a speed, a direction of travel, or a combination thereof of the moving object based on the chromatic signature. The computer is further caused to provide the velocity, the speed, the direction of travel, or a combination thereof as an output.

According to another embodiment, an apparatus comprises means for obtaining an image of a moving object captured using a camera sensor. The camera sensor employs a plurality of successive color filters to capture the image, and the plurality of successive color filters creates a chromatic signature of the moving object in the image. The apparatus also comprises means for determining a velocity, a speed, a direction of travel, or a combination thereof of the moving object based on the chromatic signature. The apparatus further comprises means for providing the velocity, the speed, the direction of travel, or a combination thereof as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining a velocity of a moving object based on chromatic signatures in an image, according to example embodiment(s);

FIGS. 2A-2C are diagrams of example chromatic signature(s) of a moving object in an image, according to example embodiment(s);

FIG. 3 is a diagram of components of a traffic platform capable of determining a velocity of a moving object based on chromatic signatures in an image, according to example embodiment(s);

FIG. 4 is a flowchart of a process for determining a velocity of a moving object based on chromatic signatures in an image, according to example embodiment(s);

FIG. 5A is a diagram depicting example chromatic signatures of moving vehicles in an image, according to example embodiment(s);

FIG. 5B is a diagram depicting an example chromatic signature of a moving wind turbine in an image, according to example embodiment(s);

FIG. 6A is a diagram of an example user interface for rendering a velocity of a moving object based on chromatic signatures in an image, according to example embodiment(s);

FIG. 6B is a diagram of an example user interface applying traffic reports updated based on moving object data, according to example embodiment(s);

FIG. 7 is a diagram of a geographic database, according to example embodiment(s);

FIG. 8 is a diagram of hardware that can be used to implement an embodiment;

FIG. 9 is a diagram of a chip set that can be used to implement an embodiment; and

FIG. 10 is a diagram of a mobile terminal (e.g., handset or vehicle or part thereof) that can be used to implement an embodiment.

### DESCRIPTION OF SOME EMBODIMENTS

Examples of a method, apparatus, and computer program for determining a velocity of a moving object based on chromatic signatures in an image are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

It is noted that the term “chromatic signature” is created by how many camera sensors capture color information (by using different color filters in quick succession—first red color is capture using a red filter, then green, blue, and sometimes intensity using a clear filter). When an object is moving (especially fast moving objects), its position changes before each filter can be used creating the chromatic signature of essentially “multiple-exposed” images.

The term “shadow” refers to a chromatic effect of an overlapping misaligned or displaced monochrome image of a moving object, where the displacement is due to a temporal cycling color filter and the motion of the object during capture or between monochrome captures.

Although various embodiments are described with respect to vehicles, it is contemplated that the approaches of the various embodiments described herein are applicable to other moving objects, such as a wind turbine, a ball, a pedestrian, animals, etc.

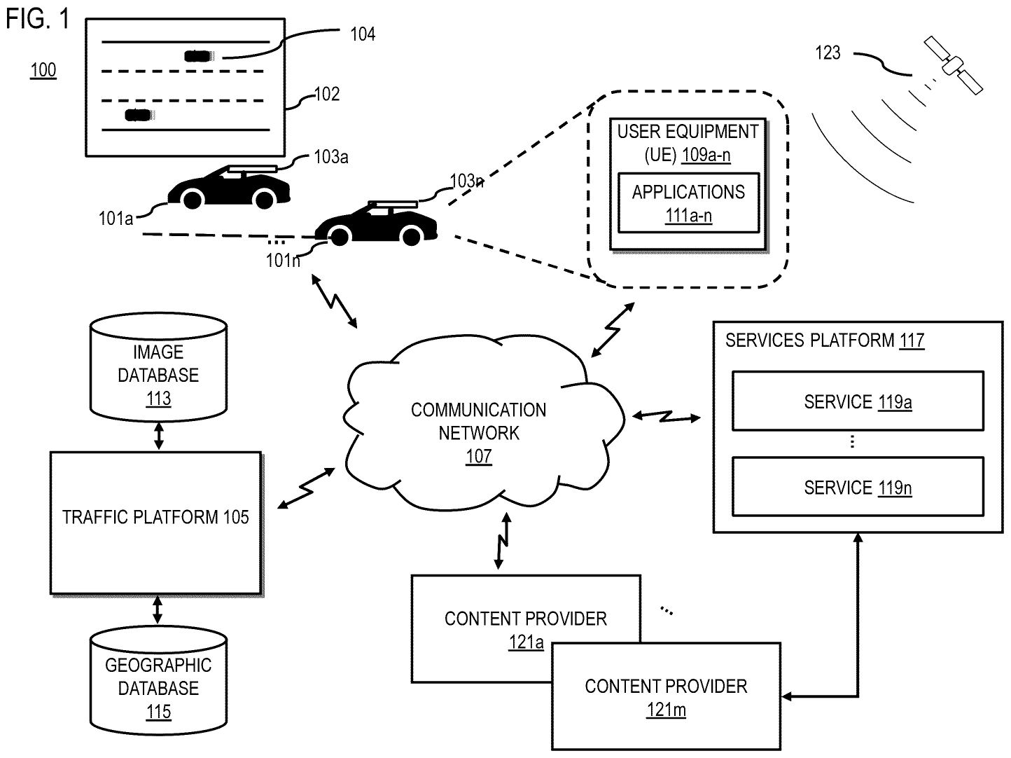

FIG. 1 is a diagram of a system capable of determining a velocity of a moving object based on chromatic signatures in an image (i.e., from predefined road segments), according to example embodiment(s). As mentioned, the satellite-based positioning sensor data and inertial measurement units (IMU) suffer from various kind of errors in estimating vehicle speeds. Map service providers have access to a large volume of satellite imagery, and the map service providers can apply computer vision to satellite imagery to detect roads/lanes via velocity measurement of moving traffic over time, estimate the direction of travel of roads/lanes, estimate the speed category or speed limit of a roadway, estimate the linear or rotational velocity of structures large enough to be seen in satellite imagery in spread out or remote areas, etc. However, these applications are limited to stationary objects, rather than moving objects. Accordingly, mapping service providers face significant technical challenges to provide a new approach to efficiently and effectively estimating the speed data of a moving object based images, especially satellite imagery.

To address these problems, the system 100 of FIG. 1 introduces a capability to determine a velocity of a moving object based on chromatic signatures in an image 102. A velocity of a moving object can be a vector representing a speed and a travel direction of the moving object, where the magnitude of the vector is the speed, and the relative magnitude of the vector components encode the travel direction. For example, the moving objects can include one or more vehicles 101a-101n (also collectively referred to as vehicles 101, e.g., autonomous vehicles, HAD vehicles, semi-autonomous vehicles, etc.) equipped with one or more vehicle sensors 103a-103n (collectively referred to as vehicle sensors 103) (e.g., a camera, LiDAR, etc.), and the image 102 depicts the moving objects with chromatic signature(s) 104. Other example moving objects include wind turbines, balls, pedestrians, animals, etc.

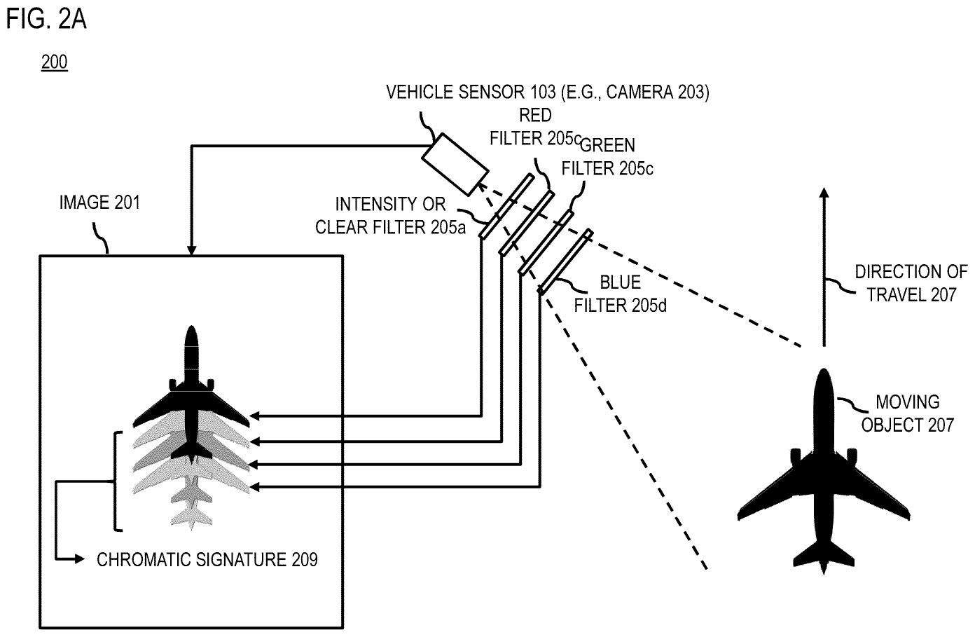

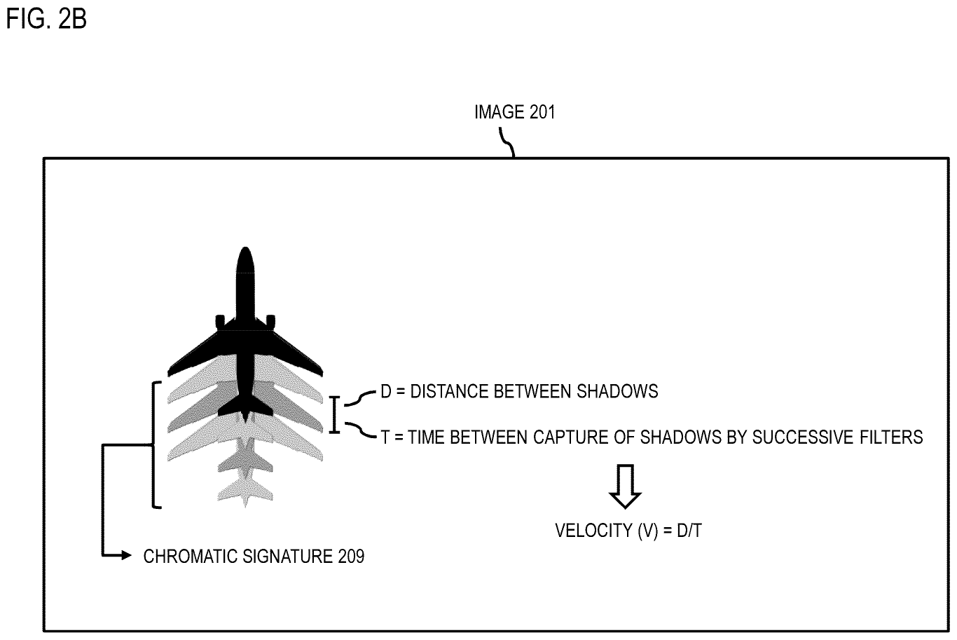

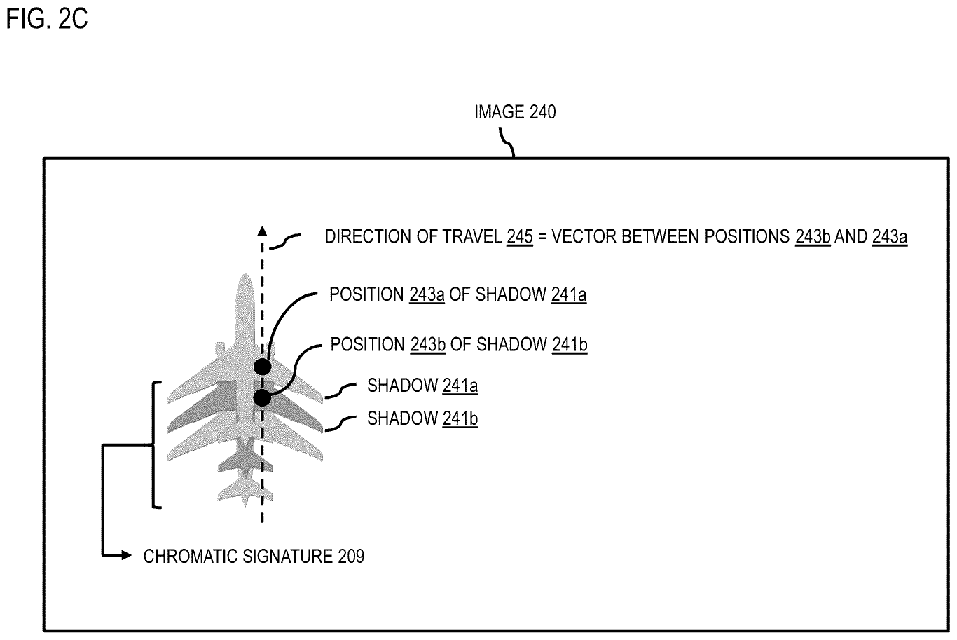

FIGS. 2A-2C are diagrams of example chromatic signature(s) of a moving object in an image, according to example embodiment(s). In one embodiment, the system 100 collects an image 201 as shown in FIG. 2A of a moving object (e.g., an air plane) from a satellite with one or more image sensors (e.g., a camera 203, LiDAR, etc.) and having connectivity to a traffic platform 105 via a communication network 107. For instance, the camera 203 can capture color information in the image 201 using different color filters in quick succession, such as a clear filter 205a for intensity, a red filter 205b for red color, a green filter 205c for green color, and a blue filter 205d for blue color. When an object 207 is moving (especially fast moving), its position changes before each filter can be used thereby creating a chromatic signature 209 in the image 201 that essentially includes “multiple-exposed” edges/shadows of the moving object 207.

In FIG. 2B, as after finding out how quickly the successive filters are applied, the system 100 can determine a time period T between a pair of “shadows” captured in the image 201. For instance, the time period T can be in a range of milliseconds. In one embodiment, the system 100 can learn from camera manufacturers how quickly the successive filters are applied. In another embodiment, the system 100 can compare the shadow set of interest with a shadow set of a known filter application time to back-calculate the time period T between the shadow set of interest.

To set the scale for the image 201 and determine a displacement D between two shadows (e.g., a vector), the system 100 needs to know the spatial resolution of the image 201 (e.g., based on the metadata of the image 201, the camera settings for capturing the image 201, etc.). Spatial resolution refers to a displacement between independent measurements, or the physical dimension that represents a pixel of the image. In an one-dimensional case, the displacement has a single element which can be a distance. In a two-dimensional case, the displacement has two elements which can be an area. In a three-dimensional case, the displacement has three elements which can be a space. For instance, this information is available online for the satellite camera that captured the image. Once the system 100 sets the scale or spatial calibration of an image, the system 100 can measure distances, areas, or spaces on the image and display the measurements in real-world units. The technique is most useful and accurate for nadir view (straight down) images, and can be adjusted for images taken at other perspective. There are free online image analysis programs that set the scale or spatial calibration of an image, and calculate a displacement in the image to the displacement it represents in the real world.

The system 100 can then determine a velocity of the moving object based on formula (1) as follows.

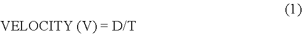

Instead of two adjacent shadows as shown in FIG. 2B, the system 100 can use any two shadows of the chromatic signature 209 to calculate the velocity of the moving object. In another embodiment, the system 100 can average velocities calculated from two or more pairs of shadows as the velocity of the moving object.

In FIG. 2C, the system 100 can pick any two shadows (e.g., shadows 241a, 241b) in an image 240 to determine a direction of travel of the moving object. For instance, the systems links a position 243a of the shadow 241a with a position 243b of the shadow 241b into a vector as the direction of travel 245 of the moving object. Instead of two adjacent shadows as shown in FIG. 2C, the system 100 can use any two shadows of the chromatic signature 209 to determine the direction of travel of the moving object. In another embodiment, the system 100 can align vectors made from two or more pairs of shadows as the direction of travel of the moving object.

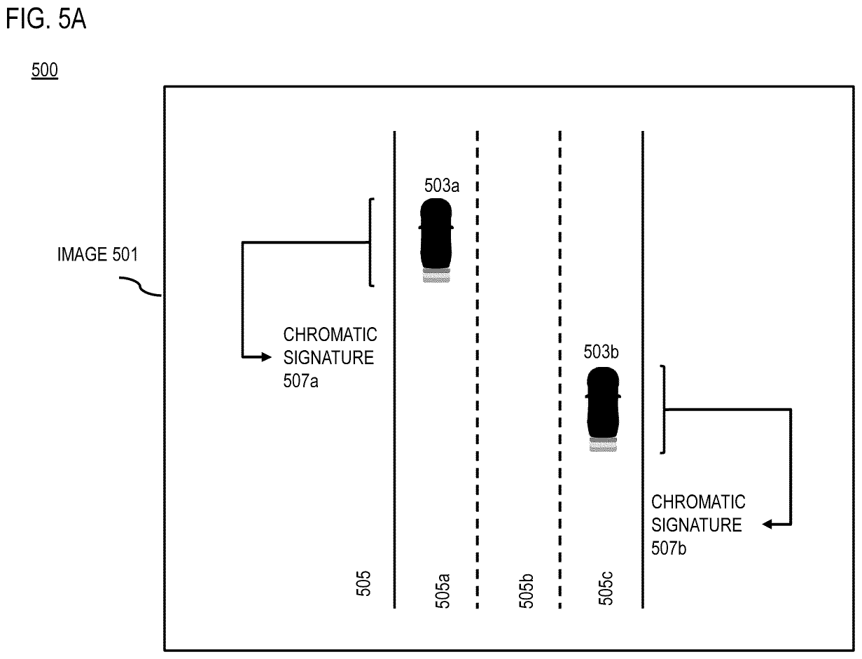

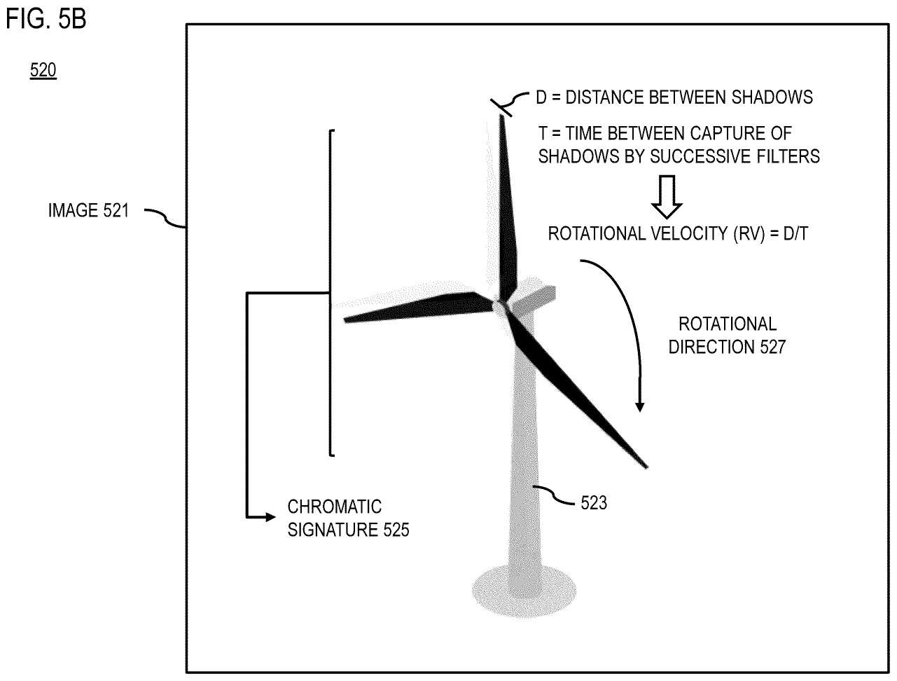

The image can be a satellite image or an aerial image (e.g., the image 201 showing an airplane with the chromatic signature 209 of in FIG. 2A, the image 501 showing vehicles with the chromatic signatures 507a, 507b in FIG. 5A, the image 521 showing a wind turbine with the chromatic signature 525 in FIG. 5B), or even a street-level image. However, the street-view image is more difficult to process since the camera is very close to the moving object thus requires additional processing to calibrate the time T and distance D between shadows.

In one instance, the vehicles 101 carry one or more user equipment (UE) 109a-109n (also collectively referenced to herein as UEs 109, e.g., a mobile device, a smartphone, etc.). In one instance, the UEs 109 may include one or more applications 111a-111n (also collectively referred to herein as applications 111) (e.g., a navigation or mapping application). In one embodiment, the system 100 can collect crowdsourced image data depicting chromatic signature(s) of moving object(s), via navigation and/or map applications such as Waze®, etc. In one embodiment, the image data and/or sensor data collected may be stored in an image database 113, a geographic database 115, or a combination thereof.

In one instance, the system 100 may also collect image data depicting chromatic signature(s) of moving object(s) from one or more other sources such as government/municipality agencies, local or community agencies (e.g., a police department), and/or third-party official/semi-official sources (e.g., a services platform 117, one or more services 119a-119n, one or more content providers 121a-121m (also collectively referred to herein as content providers 121), etc.). In one embodiment, the system 100 may collect the image data depicting chromatic signature(s) of moving object(s) from traffic incident feeds, traffic crash reports, police reports, etc. published by public authorities. In another embodiment, the system 100 can collect the image data depicting chromatic signature(s) of moving object(s) from traffic monitoring camera data, etc.

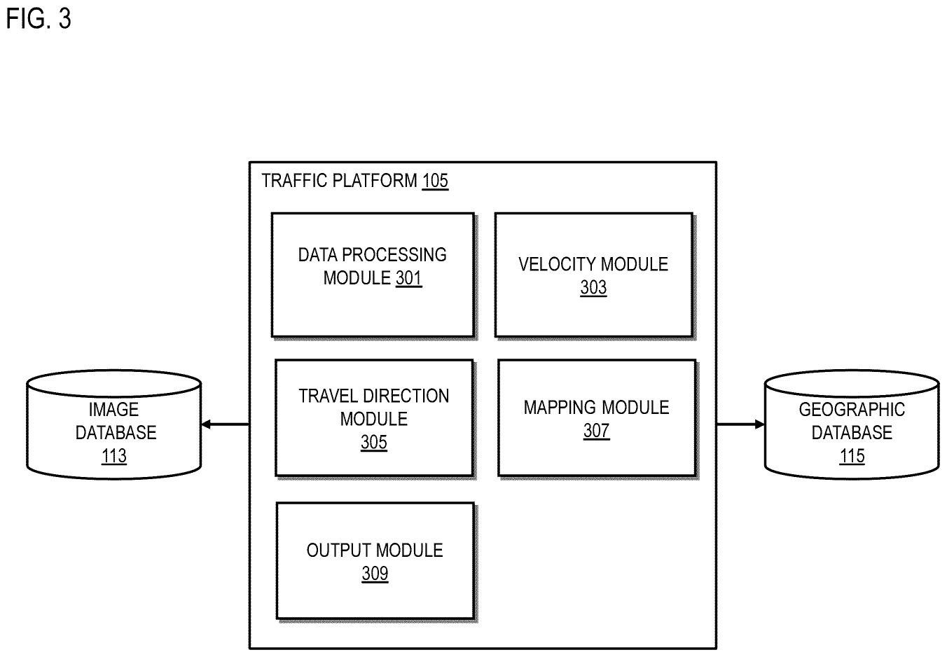

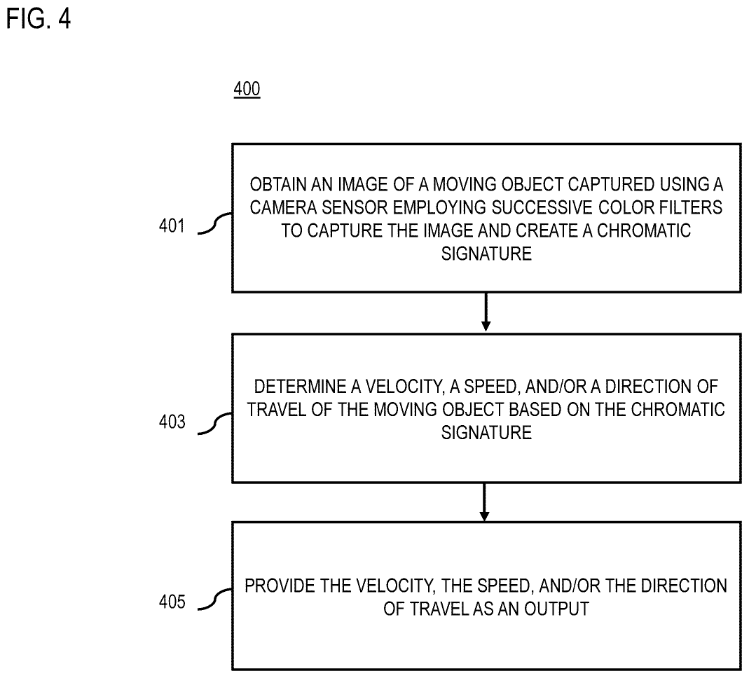

FIG. 3 is a diagram of the components of the traffic platform 105, according to example embodiment(s). By way of example, the traffic platform 105 includes one or more components for determining a velocity of a moving object based on chromatic signatures in an image, according to the various embodiments described herein. It is contemplated that the functions of these components may be combined or performed by other components of equivalent functionality. In one embodiment, the traffic platform 105 includes a data processing module 301, a velocity module 303, a travel direction module 305, a mapping module 307, and an output module 309, with connectivity to the image database 113 and the geographic database 115. The above presented modules and components of the traffic platform 105 can be implemented in hardware, firmware, software, or a combination thereof. Though depicted as a separate entity in FIG. 1, it is contemplated that the traffic platform 105 may be implemented as a module of any other component of the system 100. In another embodiment, the traffic platform 105, and/or the modules 301-309 may be implemented as a cloud-based service, local service, native application, or combination thereof. The functions of the traffic platform 105, and/or the modules 301-309 are discussed with respect to FIGS. 4-6.

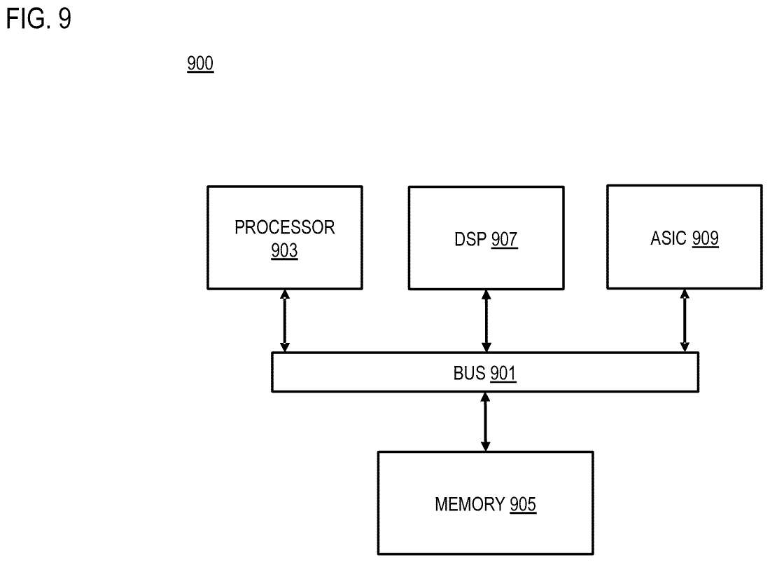

FIG. 4 is a flowchart of a process 400 for determining a velocity of a moving object based on chromatic signatures in an image, according to example embodiment(s). In various embodiments, the traffic platform 105, and/or any of the modules 301-309 may perform one or more portions of the process 400 and may be implemented in, for instance, a chip set including a processor and a memory as shown in FIG. 9. As such, the traffic platform 105 and/or the modules 301-309 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, for example, in step 401, the data processing module 301 can obtain an image (e.g., a satellite image or an aerial image such as the image 201 in FIG. 2A) of a moving object (e.g., the moving object 207 in FIG. 2A) captured using a camera sensor (e.g., the camera 203 in FIG. 2A). The camera sensor can employ a plurality of successive color filters (e.g., the filters 20a-205d in FIG. 2A) to capture the image, and the plurality of successive color filters can create a chromatic signature (e.g., the chromatic signature 209 in FIG. 2A) of the moving object in the image. In one embodiment, the chromatic signature comprises a sequence of shadows of the moving object based respectively created by each of the successive color filters.

In one embodiment, in step 403, the velocity module 303 and/or the travel direction module 305 can determine a velocity (e.g., VELOCITY (V) in FIG. 2B), a speed (e.g., a magnitude of the VELOCITY (V)), a direction of travel (e.g., a relative magnitude of the VELOCITY (V) components encode the direction of travel, such as the direction of travel 245 in FIG. 2C), or a combination thereof of the moving object based on the chromatic signature (e.g., the chromatic signature 209). For instance, the velocity module 303 can determine the velocity based on a distance between at least two shadows of the sequence of shadows and a time between when the at least two shadows were created (e.g., VELOCITY (V)=D/T in FIG. 2B). As another instance, the travel direction module 305 can determine the direction of travel based on a first position of a first shadow of the sequence of shadows (e.g., the position 243a of the shadow 241a in FIG. 2C) and a second position of a second shadow (e.g., the position 243b of the shadow 241b in FIG. 2C) of the sequence of shadows.

For example, the moving object is a vehicle traveling on a road network. FIG. 5A is a diagram 500 depicting example chromatic signatures of moving vehicles in an image, according to example embodiment(s). For instance, FIG. 5A shows an aerial image 501 of two moving vehicles 503a, 503b traveling on two different lanes 505a, 505c of a road 505. The aerial image 501 depicts chromatic signatures 507a, 507b of the vehicles 503a, 503b. After determining a time period T and a distance D between “shadows” of the chromatic signatures 507a, 507b captured in the aerial image 501, the velocity module 303 and the travel direction module 305 can determine a velocity, a speed, a direction of travel, or a combination thereof of the vehicles 503a, 503b.

In one embodiment, the mapping module 307 can locate a new road (e.g., the road 505), a new road lane (e.g., the lane 505a), or a combination thereof in the road network based on the velocity, the speed, the direction of travel, a detection of the vehicle (e.g., the vehicle 503a), a detection of the chromatic signature (e.g., the chromatic signatures 507a, 507b), or a combination thereof. In another embodiment, the mapping module 307 can store the velocity, the speed, the direction of travel, or a combination thereof as an attribute of a road (e.g., the road 505), a road lane (e.g., the lane 505a), or a combination thereof of the road network in a data record of a geographic database (e.g., the geographic database 115). In yet another embodiment, the mapping module 307 can identify a change in a configuration of a road (e.g., the road 505), a road lane (e.g., the lane 505a), or a combination thereof of the road network by comparing the velocity, the speed, the direction of travel, or a combination thereof from previously stored attributes of the road (e.g., the road 505), the road lane (e.g., the lane 505a), or a combination thereof determined from a geographic database (e.g., the geographic database 115). In yet another embodiment, the mapping module 307 can determine an attribute of a road, a road lane, or a combination thereof of the road network based on the velocity, the speed, the direction of travel, or a combination thereof.

As another example, the moving object includes a rotational component, and the velocity is a rotational velocity of the rotational component and the direction of travel is a rotational direction of the rotational component. FIG. 5B is a diagram 520 depicting an example chromatic signature of a moving wind turbine in an image, according to example embodiment(s). For instance, FIG. 5B shows an image 521 of a wind turbine 523. The image 521 depicts a chromatic signature 525 and a rotational direction 527 of the wind turbine 523. After determining a time period T and a distance D between “shadows” of the chromatic signature 525 captured in the image 521, the velocity module 303 and the travel direction module 305 can determine a rotational velocity, the rotational direction 527, or a combination thereof of the wind turbine 523.

In one embodiment, the mapping module 307 can locate a new wind turbine (e.g., the wind turbine 523) in the geographic area based on the rotational velocity, the rotational direction 527, a rotational detection of the moving object (e.g., the wind turbine 523), a detection of the chromatic signature (e.g., the chromatic signature 525), or a combination thereof. In another embodiment, the mapping module 307 can store the rotational velocity, the rotational direction 527, or a combination thereof as an attribute of a wind turbine (e.g., the wind turbine 523) in a data record of a geographic database (e.g., the geographic database 115). In yet another embodiment, the mapping module 307 can identify a change in a configuration of a wind turbine (e.g., the wind turbine 523) by comparing the rotational velocity, the rotational direction 527, or a combination thereof from previously stored attributes of the wind turbine (e.g., the wind turbine 523) determined from a geographic database (e.g., the geographic database 115). In yet another embodiment, the mapping module 307 can determine an attribute of a wind turbine (e.g., the wind turbine 523) based on the rotational velocity, the rotational direction 527, or a combination thereof. In yet another embodiment, the mapping module 307 can convert the rotational velocity, the rotational direction 527, or a combination thereof into power output volume data, and update wind power map layer.

As another example, the moving object(s) includes one or more types of animals traveling in a geographic area. For instance, an aerial image can depict migrating animals (such as lions, rhinos, elephants, birds, etc.). The aerial image also depicts chromatic signatures of the animals. After determining a time period T and a distance D between “shadows” of the chromatic signatures captured in the aerial image, the velocity module 303 and the travel direction module 305 can determine a velocity, a speed, a direction of travel, or a combination thereof of the animal.

In one embodiment, the mapping module 307 can locate a new path in the geographic area based on the velocity, the speed, the direction of travel, a detection of the animals, a detection of the chromatic signatures, or a combination thereof. In another embodiment, the mapping module 307 can store the velocity, the speed, the direction of travel, or a combination thereof as an attribute of a path in the geographic area in a data record of a geographic database (e.g., the geographic database 115). In yet another embodiment, the mapping module 307 can identify a change in a configuration of a path in the geographic area by comparing the velocity, the speed, the direction of travel, or a combination thereof from previously stored attributes of the path determined from a geographic database (e.g., the geographic database 115). In yet another embodiment, the mapping module 307 can determine an attribute of a path in the geographic area based on the velocity, the direction of travel, or a combination thereof.

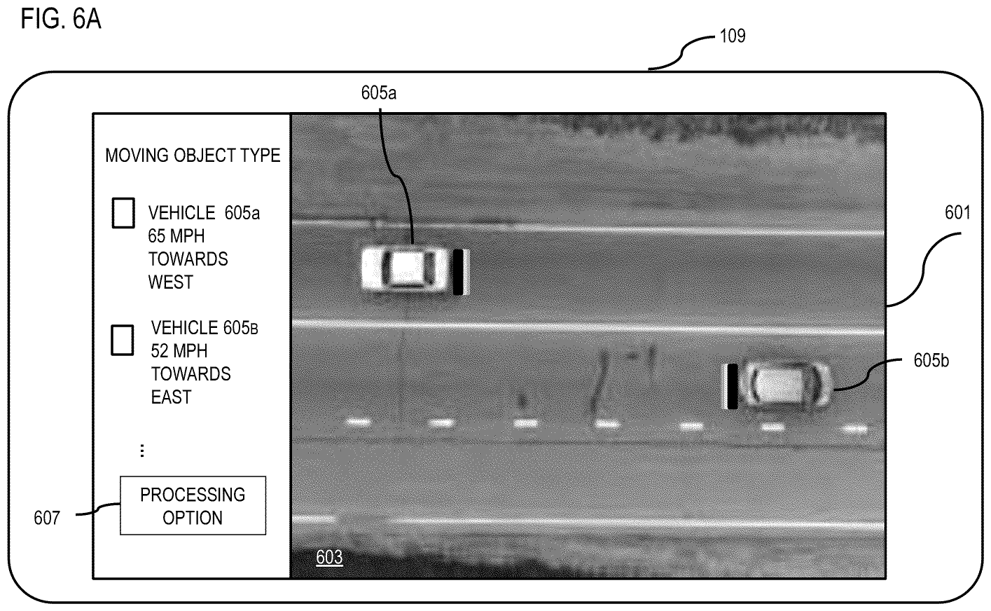

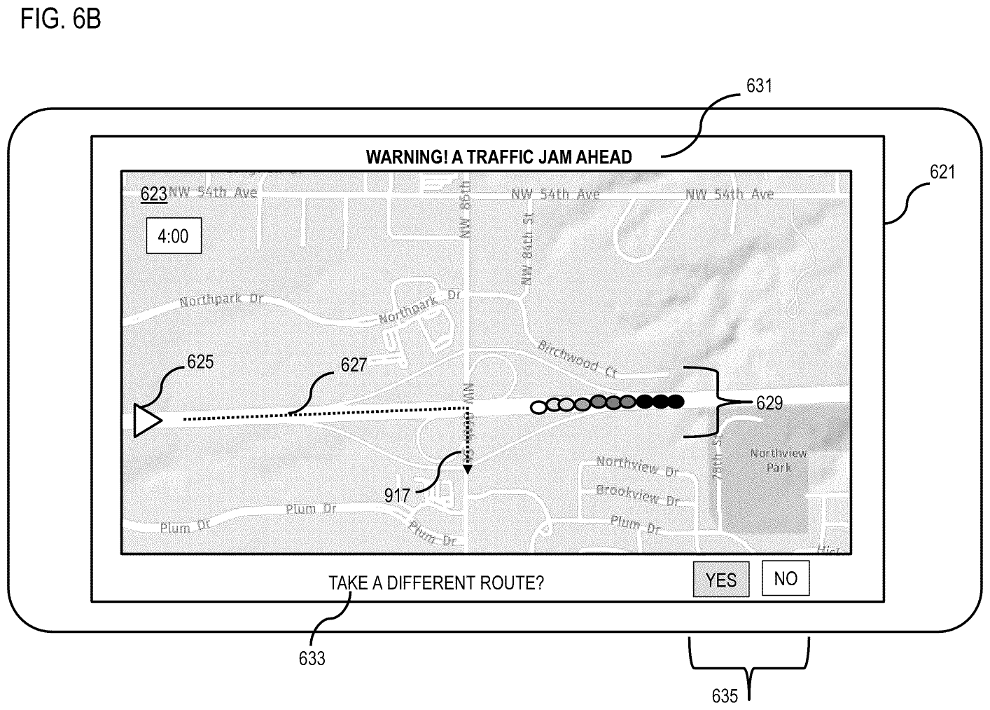

In one embodiment, in step 405, the output module 309 can provide the velocity, the speed, the direction of travel, or a combination thereof as an output. FIG. 6A is a diagram of an example user interface for rendering a velocity, a speed, and/or direction of travel of a moving object based on chromatic signatures in an image, according to example embodiment(s). In FIG. 6A, in one embodiment, the system 100 can generate a user interface (UI) 601 (e.g., via the traffic platform 105, the application 111 for traffic control, wind power management, animal migration tracking, etc.) for a UE 109 (e.g., a mobile device, a smartphone, a client terminal, etc.) that can allow a user (e.g., a traffic service provider staff, an OEM staff, etc.) to analyze, access, and/or aggregate moving object data (e.g., velocity, speed, travel direction, etc.) currently and/or over time (e.g., an hour, a day, a week, a month, a year, etc.) in an image 603 processed based on the above-described embodiments. The user can access the moving object data based on a respective data security access level. For instance, the user can select to view velocity, speed, travel direction, etc. of the vehicles 605a, 605b in FIG. 6A. In this case, vehicle 605a travelled at 65 mph towards west, while vehicle 605b travelled at 52 mph towards east. Subsequently, the user can select a button 607 to proceed with various processing options such as (1) locate a new road/lane based on the moving object data, a detection of the vehicle, a detection of the chromatic signature, etc., (2) store the velocity, speed, and/or the direction of travel as an attribute of a road/lane in a geographic database, (3) identify a change in a configuration of a road/lane by comparing the velocity, speed, and/or the direction of travel from previously stored attributes of the road/lane, (4) determine an attribute of a road/lane based on the moving object data, (5) determine a traffic jam based on moving object data, (6) determine a speed violation based on moving object data, etc.

FIG. 6B is a diagram of an example user interface applying traffic reports updated based on moving object data, according to example embodiment(s). In FIG. 6B, in one embodiment, the system 100 can generate a user interface (UI) 621 for a vehicle 101 and/or a UE 109 (e.g., a mobile device with applications 111 that can enable navigation, etc.). In one instance, the system 100 can generate the UI 621 such that it includes a map 623. For instance, the map 623 can depict a vehicle 625 (e.g., the vehicle 101) carrying a user along a path 627 taken by the vehicle 625. Upon receiving a report of a traffic accident (e.g., a traffic jam 629) occurring on the path 627 as determined based on the above-discussed embodiments, the system 100 can generate the UI 621 such that it includes an alert 631 for the traffic jam 629: “Warning! A traffic jam ahead”, and a query 633: “Take a different route?” The system 100 can receive a user selection of an input 635 with two buttons (e.g., “Yes” and “No”) to determine whether to detour from the traffic jam. In addition, the system 100 can further generate the UI 621 such that it includes an alternative route 637.

Returning to FIG. 1, in one embodiment, the traffic platform 105 has connectivity over the communication network 107 to the services platform 117 (e.g., an OEM platform) that provides one or more services 119 (e.g., image and/or sensor data collection services). By way of example, the services 119 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 117 uses the output (e.g. lane-level dangerous slowdown event detection and messages) of the traffic platform 105 to provide services such as navigation, mapping, other location-based services, etc.

In one embodiment, the traffic platform 105 may be a platform with multiple interconnected components. The traffic platform 105 may include multiple servers, intelligent networking devices, computing devices, components, and corresponding software for providing parametric representations of lane lines. In addition, it is noted that the traffic platform 105 may be a separate entity of the system 100, a part of the services platform 117, a part of the one or more services 119, or included within the vehicles 101 (e.g., an embedded navigation system).

In one embodiment, content providers 121 may provide content or data (e.g., including image data, sensor data, etc.) to the traffic platform 105, the UEs 109, the applications 111, the image database 113, the geographic database 115, the services platform 117, the services 119, and the vehicles 101. The content provided may be any type of content, such as map content, textual content, audio content, video content, image content, etc. In one embodiment, the content providers 121 may provide content that may aid in localizing a vehicle path or trajectory on a lane of a digital map or link. In one embodiment, the content providers 121 may also store content associated with the traffic platform 105, the image database 113, the geographic database 115, the services platform 117, the services 119, and/or the vehicles 101. In another embodiment, the content providers 121 may manage access to a central repository of data, and offer a consistent, standard interface to data, such as a repository of the geographic database 115.

By way of example, the UEs 109 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 109 can support any type of interface to the user (such as “wearable” circuitry, etc.). In one embodiment, a UE 109 may be associated with a vehicle 101 (e.g., a mobile device) or be a component part of the vehicle 101 (e.g., an embedded navigation system). In one embodiment, the UEs 109 may include the traffic platform 105 to determine a velocity, speed, or direction of travel of a moving object based on chromatic signatures in an image.

In one embodiment, as mentioned above, the vehicles 101, for instance, are part of a probe-based system for collecting image data, probe data and/or sensor data for detecting traffic incidents (e.g., dangerous slowdown events) and/or measuring traffic conditions in a road network. In one embodiment, each vehicle 101 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) altitude, (5) heading, (6) speed, and (7) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 101 may include sensors 103 for reporting measuring and/or reporting attributes. The attributes can also be any attribute normally collected by an on-board diagnostic (OBD) system of the vehicle 101, and available through an interface to the OBD system (e.g., OBD II interface or other similar interface).

The probe points can be reported from the vehicles 101 in real-time, in batches, continuously, or at any other frequency requested by the system 100 over, for instance, the communication network 107 for processing by the traffic platform 105. The probe points also can be map matched to specific road links stored in the geographic database 115. In one embodiment, the system 100 (e.g., via the traffic platform 105) can generate probe traces (e.g., vehicle paths or trajectories) from the probe points for an individual probe so that the probe traces represent a travel trajectory or vehicle path of the probe through the road network.

In one embodiment, as previously stated, the vehicles 101 are configured with various sensors (e.g., vehicle sensors 103) for generating or collecting image data, probe data, sensor data, related geographic/map data, etc. In one embodiment, the sensed data represents sensor data associated with a geographic location or coordinates at which the sensor data was collected. In one embodiment, the image data (e.g., stored in the image database 113) includes images collected by one or more vehicle sensors 103. By way of example, the vehicle sensors 103 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 101, switch sensors for determining whether one or more vehicle switches are engaged, and the like. Though depicted as automobiles, it is contemplated the vehicles 101 can be any type of vehicle manned or unmanned (e.g., cars, trucks, buses, vans, motorcycles, scooters, drones, etc.) that travel through road segments of a road network.

Other examples of sensors 103 of the vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle 101 along a path of travel (e.g., while on a hill or a cliff), moisture sensors, pressure sensors, etc. In a further example embodiment, sensors 103 about the perimeter of the vehicle 101 may detect the relative distance of the vehicle 101 from a physical divider, a lane line of a link or roadway, the presence of other vehicles, pedestrians, traffic lights, potholes and any other objects, or a combination thereof. In one scenario, the vehicle sensors 103 may detect weather data, traffic information, or a combination thereof. In one embodiment, the vehicles 101 may include GPS or other satellite-based receivers to obtain geographic coordinates from satellites 123 for determining current location and time. Further, the location can be determined by visual odometry, triangulation systems such as A-GPS, Cell of Origin, or other location extrapolation technologies.

In one embodiment, the UEs 109 may also be configured with various sensors (not shown for illustrative convenience) for acquiring and/or generating image data, probe data and/or other sensor data associated with a vehicle 101, a driver, other vehicles, conditions regarding the driving environment or roadway, etc. For example, such sensors may be used as GPS receivers for interacting with the one or more satellites 123 to determine and track the current speed, position, and location of a vehicle 101 travelling along a link or roadway. In addition, the sensors may gather tilt data (e.g., a degree of incline or decline of the vehicle during travel), motion data, light data, sound data, image data, weather data, temporal data and other data associated with the vehicles 101 and/or UEs 109. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via communication network 107 as probe data (e.g., GPS probe data) according to any known wireless communication protocols. For example, each UE 109, application 111, user, and/or vehicle 101 may be assigned a unique probe identifier (probe ID) for use in reporting or transmitting said probe data collected by the vehicles 101 and/or UEs 109. In one embodiment, each vehicle 101 and/or UE 109 is configured to report probe data as probe points, which are individual data records collected at a point in time that records telemetry data.

In one embodiment, the traffic platform 105 retrieves aggregated probe points gathered and/or generated by the vehicle sensors 103 and/or the UE 109 resulting from the travel of the UEs 109 and/or vehicles 101 on a road segment of a road network. In one instance, the image database 113 stores a plurality of images generated by different vehicle sensors 103, UEs 109, applications 111, vehicles 101, etc. over a period while traveling in a monitored area. A time sequence of probe points specifies a trajectory—i.e., a path traversed by a UE 109, application 111, vehicle 101, etc. over the period.

In one embodiment, the communication network 107 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 101, vehicle sensors 103, traffic platform 105, UEs 109, applications 111, services platform 117, services 119, content providers 121, and/or satellites 123 communicate with each other and other components of the system 100 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI reference model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

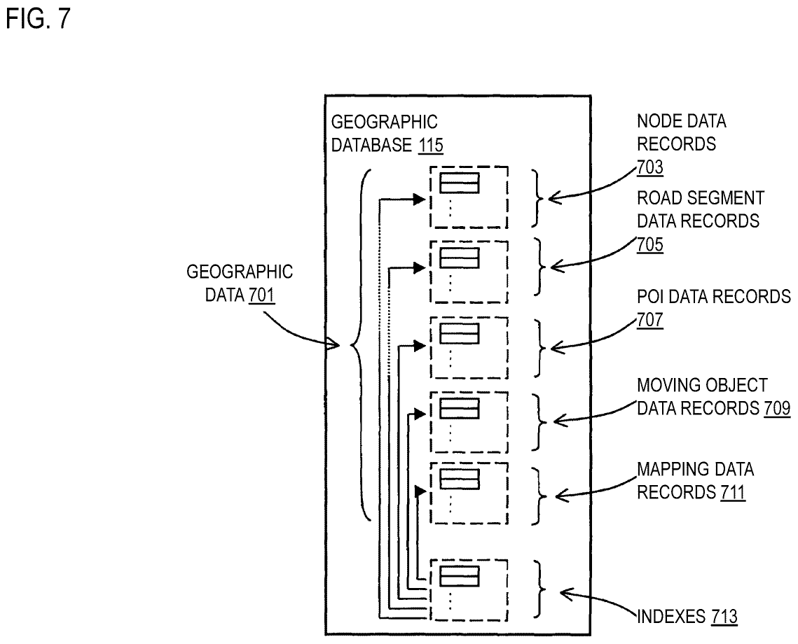

FIG. 7 is a diagram of a geographic database (such as the database 115), according to example embodiment(s). In one embodiment, the geographic database 115 includes geographic data 701 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on Light Detection and Ranging (LiDAR) or equivalent technology to collect very large numbers of 3D points depending on the context (e.g., a single street/scene, a country, etc.) and model road surfaces and other map features down to the number lanes and their widths. In one embodiment, the mapping data (e.g., mapping data records 711) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 703, road segment or link data records 705, POI data records 707, moving object data records 709, mapping data records 711, and indexes 713, for example. More, fewer or different data records can be provided. In one embodiment, additional data records (not shown) can include cartographic (“carto”) data records, routing data, and maneuver data. In one embodiment, the indexes 713 may improve the speed of data retrieval operations in the geographic database 115. In one embodiment, the indexes 713 may be used to quickly locate data without having to search every row in the geographic database 115 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points (such as intersections) corresponding to the respective links or segments of the road segment data records 705. The road link data records 705 and the node data records 703 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 707. The geographic database 115 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city). In one embodiment, certain attributes, such as lane marking data records, mapping data records and/or other attributes can be features or layers associated with the link-node structure of the database.

In one embodiment, the geographic database 115 can also include moving object data records 709 for storing image data, moving object data (e.g., object type, number, location, velocity, speed, travel direction, etc.), aggregated moving object data (e.g., moving object map layers, traffic reports, wind power management reports, animal migration reports, etc.), training data, prediction models, annotated observations, computed featured distributions, sampling probabilities, and/or any other data generated or used by the system 100 according to the various embodiments described herein. By way of example, the moving object data records 709 can be associated with one or more of the node records 703, road segment records 705, and/or POI data records 707 to support localization or visual odometry based on the features stored therein and the corresponding estimated quality of the features. In this way, the records 709 can also be associated with or used to classify the characteristics or metadata of the corresponding records 703, 705, and/or 707.

In one embodiment, as discussed above, the mapping data records 711 model road surfaces and other map features to centimeter-level or better accuracy. The mapping data records 711 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 711 are divided into spatial partitions of varying sizes to provide mapping data to vehicles 101 and other end user devices with near real-time speed without overloading the available resources of the vehicles 101 and/or devices (e.g., computational, memory, bandwidth, etc. resources).

In one embodiment, the mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 711.

In one embodiment, the mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content provider 121 in association with the services platform 117 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles 101 and/or UEs 109) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a UE 109, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for determining a velocity, speed, or direction of travel of a moving object based on chromatic signatures in an image may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

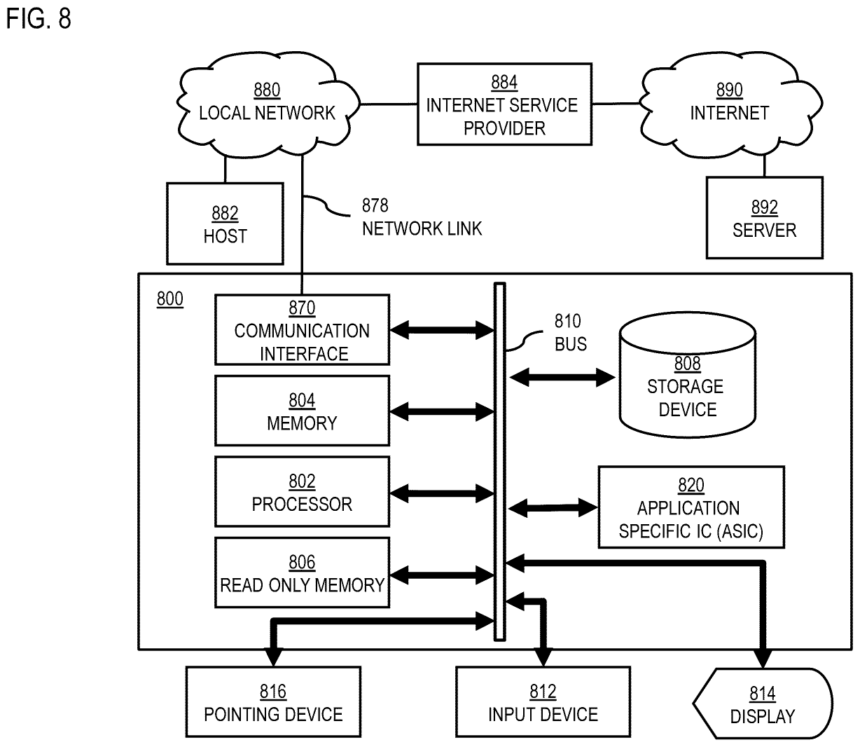

FIG. 8 illustrates a computer system 800 upon which an embodiment of the invention may be implemented. Computer system 800 is programmed (e.g., via computer program code or instructions) to determine a velocity, speed, or direction of travel of a moving object based on chromatic signatures in an image as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to determining a velocity, speed, or direction of travel of a moving object based on chromatic signatures in an image. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for determining a velocity, speed, or direction of travel of a moving object based on chromatic signatures in an image. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for determining a velocity, speed, or direction of travel of a moving object based on chromatic signatures in an image, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 107 for determining a velocity, speed, or direction of travel of a moving object based on chromatic signatures in an image.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to determine a velocity, speed, or direction of travel of a moving object based on chromatic signatures in an image as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to determine a velocity, speed, or direction of travel of a moving object based on chromatic signatures in an image. The memory 905 also stores the data associated with or generated by the execution of the inventive steps.

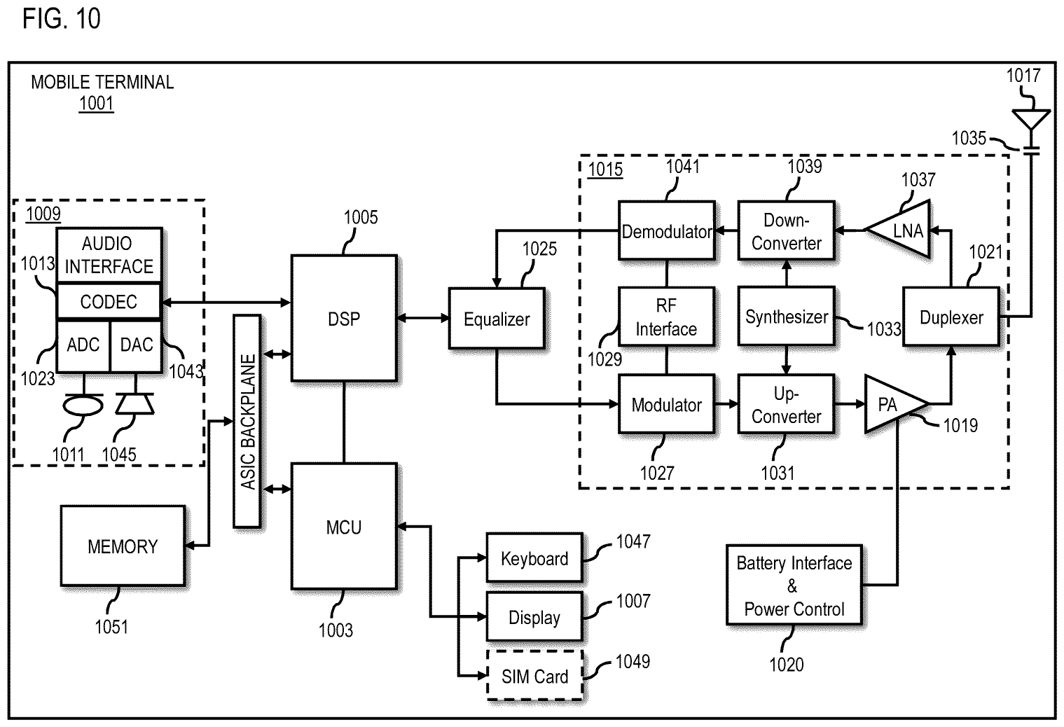

FIG. 10 is a diagram of exemplary components of a mobile terminal 1001 (e.g., handset or vehicle or part thereof) capable of operating in the system of FIG. 1, according to example embodiment(s). Generally, a radio receiver is often defined in terms of front-end and back-end characteristics. The front-end of the receiver encompasses all of the Radio Frequency (RF) circuitry whereas the back end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003-which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to determine a velocity, speed, or direction of travel of a moving object based on chromatic signatures in an image. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
obtaining an image of a moving object captured using a camera sensor, wherein the camera sensor employs a plurality of successive color filters to capture the image, and wherein the plurality of successive color filters creates a chromatic signature of the moving object in the image;
determining a velocity, a speed, a direction of travel, or a combination thereof of the moving object based on the chromatic signature; and
providing the velocity, the speed, the direction of travel, or a combination thereof as an output.

2. The method of claim 1, wherein the chromatic signature comprises a sequence of shadows of the moving object based respectively created by each of the successive color filters.

3. The method of claim 2, further comprising:
determining the velocity based on a distance between at least two shadows of the sequence of shadows and a time between when the at least two shadows were created.

4. The method of claim 2, further comprising:
determining the direction of travel based on a first position of a first shadow of the sequence of shadows and a second position of a second shadow of the sequence of shadows.

5. The method of claim 1, wherein the moving object is a vehicle traveling on a road network.

6. The method of claim 5, further comprising:
locating a new road, a new road lane, or a combination thereof in the road network based on the velocity, the speed, the direction of travel, a detection of the vehicle, a detection of the chromatic signature, or a combination thereof.

7. The method of claim 5, further comprising:
storing the velocity, the speed, the direction of travel, or a combination thereof as an attribute of a road, a road lane, or a combination thereof of the road network in a data record of a geographic database.

8. The method of claim 5, further comprising:
identifying a change in a configuration of a road, a road lane, or a combination thereof of the road network by comparing the velocity, the speed, the direction of travel, or a combination thereof from previously stored attributes of the road, the road lane, or a combination thereof determined from a geographic database.

9. The method of claim 5, further comprising:
determining an attribute of a road, a road lane, or a combination thereof of the road network based on the velocity, the speed, the direction of travel, or a combination thereof.

10. The method of claim 1, wherein the moving object includes a rotational component, and wherein the velocity is a rotational velocity of the rotational component and the direction of travel is a rotational direction of the rotational component.

11. The method of claim 1, wherein the image is a satellite image or an aerial image.

12. An apparatus comprising:
at least one processor; and
at least one memory including computer program code for one or more programs,
the at least one memory and the computer program code configured to, with the at least one processor, cause the apparatus to perform at least the following,
obtain an image of a moving object captured using a camera sensor, wherein the camera sensor employs a plurality of successive color filters to capture the image, and wherein the plurality of successive color filters creates a chromatic signature of the moving object in the image;
determine a velocity, a speed, a direction of travel, or a combination thereof of the moving object based on the chromatic signature; and
provide the velocity, the speed, the direction of travel, or a combination thereof as an output.

13. The apparatus of claim 12, wherein the chromatic signature comprises a sequence of shadows of the moving object based respectively created by each of the successive color filters.

14. The apparatus of claim 13, wherein the apparatus is further caused to perform:
determine the velocity based on a distance between at least two shadows of the sequence of shadows and a time between when the at least two shadows were created.

15. The apparatus of claim 13, wherein the apparatus is further caused to perform:
determine the direction of travel based on a first position of a first shadow of the sequence of shadows and a second position of a second shadow of the sequence of shadows.

16. The apparatus of claim 12, wherein the moving object is a vehicle traveling on a road network, and the apparatus is further caused to perform at least one of:
locate a new road, a new road lane, or a combination thereof in the road network based on the velocity, the speed, the direction of travel, a detection of the vehicle, a detection of the chromatic signature, or a combination thereof,
store the velocity, the speed, the direction of travel, or a combination thereof as an attribute of a road, a road lane, or a combination thereof of the road network in a data record of a geographic database,
identify a change in a configuration of a road, a road lane, or a combination thereof of the road network by comparing the velocity, the speed, the direction of travel, or a combination thereof from previously stored attributes of the road, the road lane, or a combination thereof determined from a geographic database, and
determine an attribute of a road, a road lane, or a combination thereof of the road network based on the velocity, the direction of travel, or a combination thereof.

17. The apparatus of claim 12, wherein the moving object includes a rotational component, and wherein the velocity is a rotational velocity of the rotational component and the direction of travel is a rotational direction of the rotational component.

18. A non-transitory computer readable storage medium including one or more sequences of one or more instructions which, when executed by one or more processors, cause an apparatus to at least perform:
obtaining an image of a moving object captured using a camera sensor, wherein the camera sensor employs a plurality of successive color filters to capture the image, and wherein the plurality of successive color filters creates a chromatic signature of the moving object in the image;
determining a velocity, a speed, a direction of travel, or a combination thereof of the moving object based on the chromatic signature; and
providing the velocity, the speed, the direction of travel, or a combination thereof as an output.

19. The non-transitory computer readable storage medium of claim 18, wherein the chromatic signature comprises a sequence of shadows of the moving object based respectively created by each of the successive color filters.

20. The non-transitory computer-readable storage medium of claim 19, wherein the apparatus is caused to further perform:
determining the velocity based on a distance between at least two shadows of the sequence of shadows and a time between when the at least two shadows were created.
